(19) United States
(12) Patent Application Publication
(10) Pub. No.: US 2008/0222112 A1
(43) Pub. Date: Sep. 11, 2008

(54) Method and System for Document Searching and Generating to do List

(75) Inventor: David A. Morales, El Paso, TX (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: ALTEP, INC., El Paso, TX (US)

(21) Appl. No.: 12/038,799

(22) Filed: Feb. 27, 2008

Related U.S. Application Data
(60) Provisional application No. 60/893,602, filed on Mar. 7, 2007.
(60) Provisional application No. 60/893,612, filed on Mar. 7, 2007.
(60) Provisional application No. 60/911,822, filed on Apr. 13, 2007.

(51) Int. Cl. G06F 17/30

(52) U.S. Cl. 707/3; 707/E17.014

(57) ABSTRACT

A method and system for assigning a document review lists to users based on a search query. In one embodiment, the method comprises receiving a search query; generating a first list of documents based on the search query; distributing the first list of documents into N document lists; assigning each of a plurality of document lists to at least one of a plurality of users. In other embodiments, the process includes a machine-readable medium that provides instructions for a processor, which when executed by the processor cause the processor to perform a method of the present invention.

### CROSS-REFERENCE TO RELATED APPLICATIONS

This application claims benefit and priority under 35 U.S.C. §119(e) of the following co-pending provisional applications having at least one common inventor with this application: Ser. No. 60/893,612, filed Mar. 7, 2007, entitled “Method and System for Searching and Generating To Do List”; Ser. No. 60/893,602, filed Mar. 7, 2007, entitled “Method and System for Document Searching”; Ser. No. 60/911,822, filed Apr. 13, 2007, entitled “Method and System for Hierarchical Document Management in a Document Review System”. The entire disclosures of the above applications are incorporated herein by reference.

The entire disclosure of commonly-assigned co-pending application Ser. No. not yet assigned, attorney docket no. 101915-200101/US, entitled “Method and System for Rules Based Tag Management in a Document Review System,” by inventor Willem van de Berge, filed the same day as this application, is incorporated herein by reference.

The entire disclosure of commonly-assigned co-pending application Ser. No. not yet assigned, attorney docket no. 101915-200201/US, entitled “Method and System for Document Searching,” by inventor David A. Morales, filed the same day as this application, is incorporated herein by reference.

The entire disclosure of commonly-assigned co-pending application Ser. No. not yet assigned, attorney docket no. 101915-200401/US, entitled “Method and System for Universal File Types in a Document Review System,” by inventor Willem van den Berge, filed the same day as this application, is incorporated herein by reference.

The entire disclosure of commonly-assigned co-pending application Ser. No. not yet assigned, attorney docket no. 101915-200501/US, entitled “Method and System for Hierarchical Document Management in a Document Review System,” by inventor David A. Morales, filed the same day as this application, is incorporated herein by reference.

### TECHNICAL FIELD

This invention relates generally to the field of document review systems. More particularly, the invention relates to a method and system for searching documents.

### BACKGROUND

Document review systems are used for managing the document review in the discovery phase of litigation. Document review systems are employed to process search queries to identify documents with specific words or phrases within a set of documents and identify documents that meet specified criteria with common identifiers, such as tags. Some document review systems allow search queries to be saved for subsequent use. Some document review systems allow for search results to be saved. What is needed is a method to compare search results over time.

### BRIEF SUMMARY

A method and system for assigning a list of documents to be reviewed by users based on a search query. In one embodiment, the method comprises receiving a search query; generating a first list of documents based on the search query; distributing the first list of documents into N document lists; assigning each of a plurality of document lists to at least one of a plurality of users. In other embodiments, the process includes a machine-readable medium that provides instructions for a processor, which when executed by the processor cause the processor to perform a method of the present invention.

### BRIEF DESCRIPTION OF THE DRAWINGS

These and other features, aspects, and advantages of the present invention will become better understood with regard to the following description, appended claims, and accompanying drawings where:

FIG. 1 illustrates a block diagram of one embodiment of a system of the invention.

FIG. 2 illustrates one embodiment of a flow diagram of a method of comparing two document search results.

FIG. 3 illustrates one embodiment of a representation of a search result assignment process.

FIG. 4 illustrates another embodiment of a representation of a screen image of a to do list manager process.

FIG. 5 shows a system having a machine-readable medium to store a set of instructions to perform a process according to one embodiment.

### DETAILED DESCRIPTION

At least some embodiments of the disclosure relate to a method and process for searching documents.

The following description and drawings are illustrative and are not to be construed as limiting. Numerous specific details are described to provide a thorough understanding of the disclosure. However, in certain instances, well known or conventional details are not described in order to avoid obscuring the description. References to one or an embodiment in the present disclosure can be, but not are not necessarily references to the same embodiment; and such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

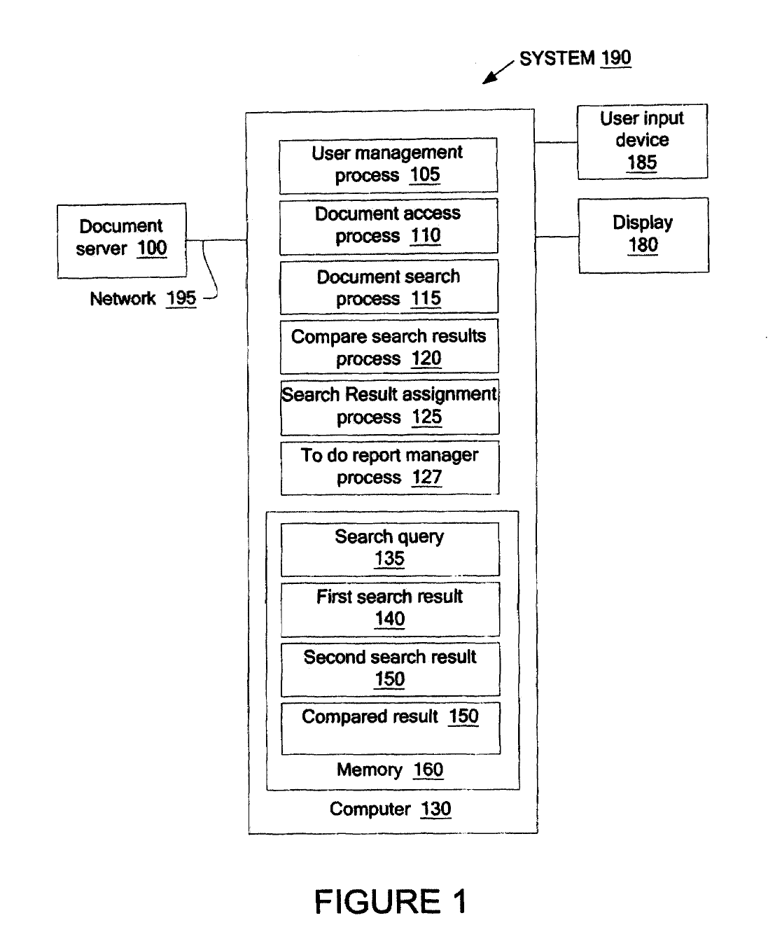

FIG. 1 illustrates one embodiment of a system 190 of the present invention. The system 190 includes a computer 130 coupled to a user-input device 180, a display 180 and a memory 160. The computer 130 has a user management process 105, a document access process 110, a document search process 115, a compare search results process 120, a search result assignment process 125 and a to do report manager process 127. The computer 130 is coupled through a network 195 to communicate with a document server 100. In one embodiment, the system 190 is used for document review during the discovery phase of litigation. In other embodiments, the system 190 is used in other document review applications.

The user management process 105 is used to create and maintain accounts for users of the document review system. Each user account may have a user name, password, and access limitations associated with the account. Furthermore, activities such as the number of documents viewed may be tracked by user for project management purposes.

In one embodiment, the computer 130 receives a request for a search query 135 through the user input device 180. The search query 135 is stored in a memory 160. The documents are stored in a folder structure. The search query 135 is limited to a scope of documents to be searched by indicating which of the folders should be included. The search query 135 includes a logical expression used to evaluate whether a document satisfies the search query.

The document access process 110 accesses the documents within the scope of the search query 135 and the document search process 115 tests the documents against the search query 135 to generate a first search result 140.

In one embodiment, the search result assignment process 125 is used to assign the documents associated with the first search result 140 to users managed by the user management process 105, The documents in the first search result 140 are split into several lists and each list is assigned to a user as described herein. In this way, these documents may be distributed among several document reviewers for document review.

In one embodiment, the search query 135 may be performed at a later time to identify documents that were not included in the first search result 140 but now meet the requirements of the query and need to be assigned to users.

At a later time, the search query 135 is retrieved from the memory 160 based on a search request submitted via the user input device 180. The document access process 110 accesses the documents within the scope of the search query 135 and the document search process 115 tests the documents against the search query 135 to generate a second search result 150.

In one embodiment, the compare search result process 120 compares the first search result 140 and the second search result 150 to generate a compared result 145. In one embodiment, the compared result is a list of documents that are in the second search result 150 but not the first search result 140. In another embodiment, the compared result is a list of documents that are in the first search result 140 but not the second search result 150. In another embodiment, the compared result 145 includes all documents in either the first or second search result with an indicator as to which of the first and second search result the document is in.

In one embodiment, the compared result 145 includes a list of documents in the second search result 150 but not the first search result 140. Documents in the first search result 140 may have been assigned to users for review when the last search query was performed. This list of documents may indicate documents that need to be assigned to a user for document review since the assignments at the time of the last search query. Document review may include reading the document to determine whether the document is relevant to a legal case, for example.

A to do report manager process 127 is used to track the progress of document review activities by list of documents assigned.

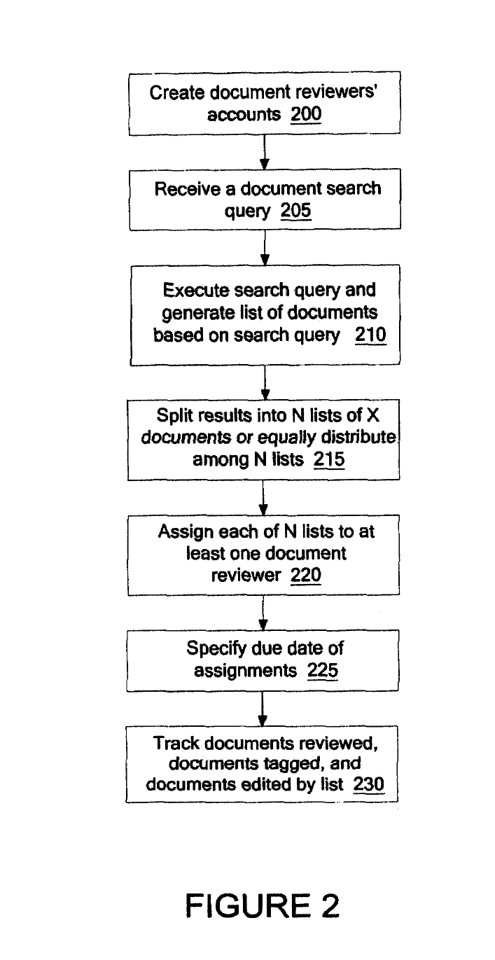

FIG. 2 is a flow diagram of a method of the present invention and is described in conjunction with FIG. 1 and FIGS. 3 and 4 representing screen images in one embodiment of the invention.

In process 200, user accounts are created. Each user account may have a user name, password, and access limitation associated with the account. Furthermore, documents viewed and other activities may be tracked by user for project management purposes.

In process 205, a document search query is received. A search query is an expression used to identify documents that meet certain criteria with a specified scope of documents to be searched.

In process 210, a search query is executed and a first list of documents is generated based on the search query. In one embodiment, the first list of documents consists of those that satisfy the search query. In this case the whole list of documents in the search query result are assigned to users.

In another embodiment the search query result is compared against a previous search query result to generate a compared result. The first list of documents is the compared result. The compared result is a list of documents that are in the second search result 150 but not the first search result 140. In another embodiment, the compared result is a list of documents that are in the first search result 140 but not the second search result 150. In another embodiment, the compared result 145 includes all documents either the first or second search result with an indicator as to which of the two lists the document is in.

In one embodiment, the list of documents only includes those that are included in the later search query, but not the earlier search query. In this way, documents that had not been assigned at the time of the earlier search query are included in the list of documents and can not be assigned to users.

In process 215, the a list of documents generated by executing a query and saving the result set is split into N lists of documents. In one embodiment, the user specifies X, the number of documents that are to be included in each list. In some cases, the number of documents in the first list of documents is not evenly divisible into N so some of the N lists may have some number of documents less or more than X. In another embodiment, the user specifies N, the number of lists to be generated. In some cases, the number of documents in the first list of documents is not evenly divisible by N so some of the N lists may have some number of documents more or less document than X.

In one embodiment, the number of documents distributed into the N lists is the documents in the first list of documents. If these documents have other attached documents, these are optionally assigned with the document to which they are attached. In another embodiment, the number of documents distributed into the N lists is the documents in the first list of documents plus the number of documents attached to the documents in the first list of documents. In some cases, the documents attached to a document are assigned to the same list as the document because those documents are related and would be better reviewed by the same person. This grouping of attached documents into the same one of the N lists may lead to some additional in the number of documents distributed among the N lists.

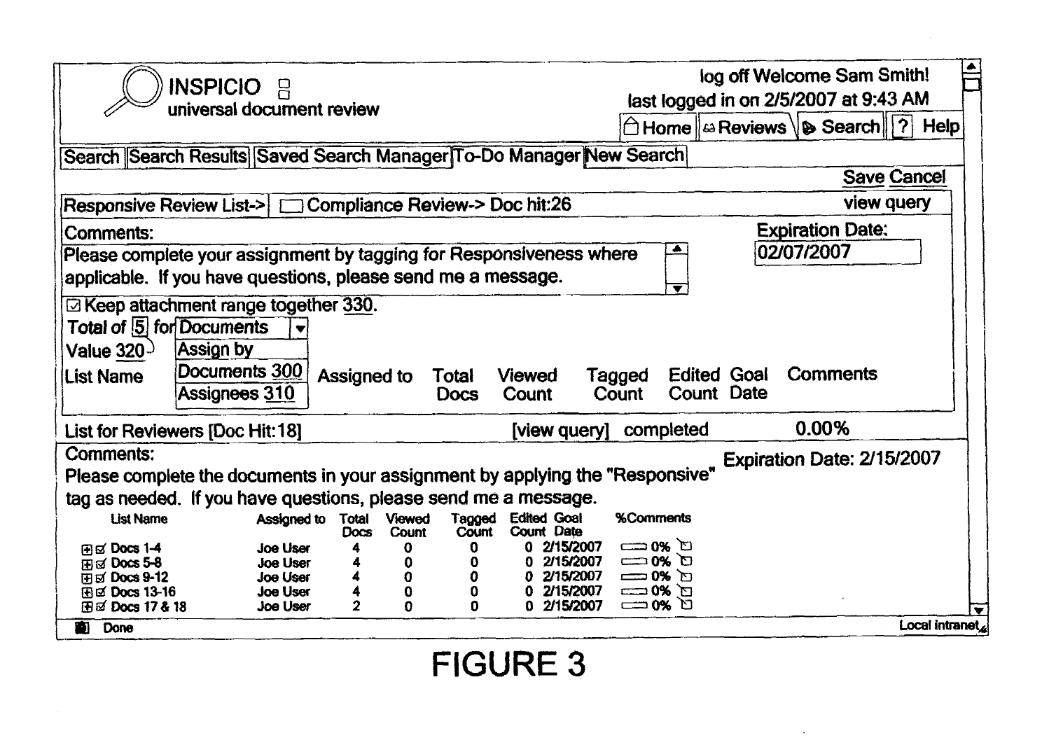

In process 220, each of the N lists are assigned to at least one of the users for document review. FIG. 3 illustrates a representation of a screen image of search result assignment process. If Assign by Documents 300 is selected, a value 320 specified is X, the number of documents to be assigned per list, in this case 5. If Assign by Assignees 310 is selected, the value 320 specified is N, the number of lists, in this case 5, over which the documents are to be distributed. If the check box adjacent to keep attachment range together 330 is selected, a document and its attachments are assigned to the same one of the N lists.

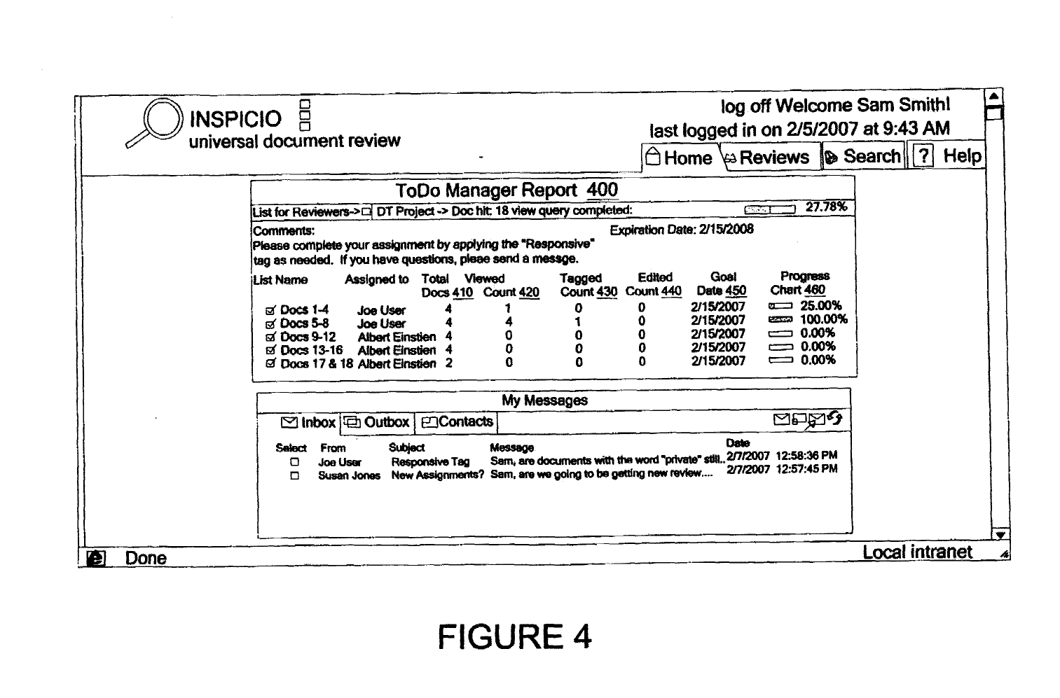

FIG. 4 illustrates a representation of a screen image of a to do report manager. A to do report manager report 400 reports progress indicators by each one of the N lists. Some indicators include total docs 410, viewed count 420, tagged count 430 and edited count 440. A goal date 450 and progress chart 460 is shown.

The total docs 410 displays the total documents included in that list. The viewed count 420 displays the number of documents that have been viewed in that list by the user. The tagged count 430 displays the number of documents that have been tagged in that list by the user. The edited count 440 includes the number of documents that have been edited in that list by the user. The goal date 450 displays the date the document review for that list is expected to be completed, The progress chart 460 includes a bar chart showing the percentage of documents in that list that have been viewed.

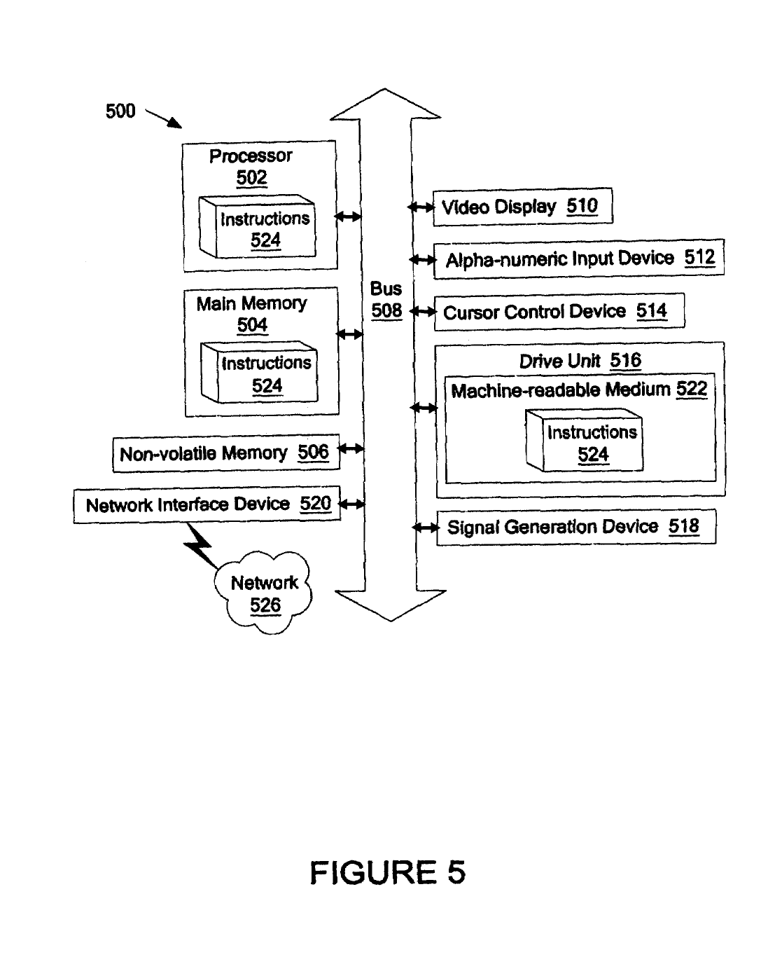

FIG. 5 shows a diagrammatic representation of a machine in the exemplary form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

The computer system 500 includes a processor 502 (e.g., a central processing unit (CPU) a graphics processing unit (GPU) or both), a main memory 504 and a nonvolatile memory 506, which communicate with each other via a bus 508. In some embodiments, the computer system 500 may be a laptop computer, personal digital assistant (PDA) or mobile phone, for example. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 540. The disk drive unit 516 includes a machine-readable medium 522 on which is stored one or more sets of instructions: (e.g., software 524) embodying any one or more of the methodologies or functions described herein. The software 524 may also reside, completely or at least partially, within the main-memory 504 and/or within the processor 502 during execution thereof by the computer system 500, the main memory 504 and the processor 502 also constituting machine-readable media. The software 524 may further be transmitted or received over a network 526 via the network interface device 520.

While the machine-readable medium 522 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method for performing document review comprising:
receiving a search query;
generating a first list of documents based on a search query, wherein the first list of documents consists of documents selected from a plurality of documents that satisfy the search query;
distributing the first list of documents into N document lists, where N is a number;
assigning each document list to at least one of a plurality of users.

2. The method of claim 1 further comprising:
searching the plurality of documents using the search query to generate a second list of documents;
searching the plurality of documents using the search query to generate a third list of documents;
wherein the first list of documents consists of the documents in the third list of documents but not in the second list of documents.

3. The method of claim 1 wherein the distributing the first list of documents into a plurality of document lists comprises specifying N, wherein the first list of documents is approximately evenly distributed among the N lists.

4. The method of claim 1 wherein the distributing the first list of documents into a plurality of document lists comprises specifying X, where X is a number, wherein the X documents in the first list of documents is approximately evenly distributed among the N lists.

5. The method of claim 1 wherein the documents in the first list of documents are approximately evenly distributed among the N lists based on the number of documents in the search result without counting any attachments.

6. The method of claim 1 wherein the documents in the first list of documents are approximately evenly distributed among the N lists based on the number of documents in the search result including attachments.

7. The method of claim 1 wherein displaying document review performance indicators for at least one of the N lists.

8. A machine-readable medium that provides instructions for a processor, which when executed by the processor cause the processor to perform a method comprising:
receiving a search query;
generating a first list of documents based on a search query, wherein the first list of documents consists of documents selected from a plurality of documents that satisfy the search query;
distributing the first list of documents into N document lists, where N is a number;
assigning each document list to at least one of a plurality of users.

9. The method machine-readable medium of claim 8 further comprising:
searching a plurality of documents using the search query to generate a second list of documents;
searching a plurality of documents using the search query to generate a third list of documents;
wherein the first list of documents consists of the documents in the third list of documents but not in the second list of documents.

10. The machine-readable medium of claim 8 wherein the distributing of the first list of documents into a plurality of document lists comprises specifying N, wherein the first list of documents is approximately evenly distributed among the N lists.

11. The machine-readable medium of claim 8 wherein the distributing the first list of documents into a plurality of document lists comprises specifying X, where X is a number, wherein the X documents in the first list of documents is approximately evenly distributed among the N lists.

12. The machine-readable medium of claim 8 wherein the documents in the first list of documents are approximately evenly distributed among the N lists based on the number of documents in the search result without counting any attachments.

13. The machine-readable medium of claim 8 wherein the documents in the first list of documents are approximately evenly distributed among the N lists based on the number of documents in the search result including attachments.

14. The machine-readable medium of claim 8 wherein displaying document review performance indicators for at least one of the N lists.

15. A system comprising:
a computer coupled to the user-input device, the server and a display, the computer comprising:
a user management process having a plurality of users;
a document access process to request documents from a set of documents;
a document search process to generate a first list based on the search query, wherein the first list of documents consists of documents selected from a plurality of documents that satisfy the search query;
a search result assignment process to distribute the first list of documents into N document lists where N is a number and to assign each document list to at least one of the plurality of users.

16. The system of claim 15 wherein the computer further comprises a compare search results process to generate the first list of documents, the first list of documents consisting of documents that are not in the results of the search query in a first period in time but are in the results of the search query in a second period in time.

17. The system of claim 15 wherein the search result assignment process is configured to distribute the first list of documents into N document lists, wherein the first list of documents is approximately evenly distributed among the N lists.

18. The system of claim 15 wherein the computer further comprises a report manager process, the report manager process is configured to display document review performance indicators for at least one of the N lists.
